(19) United States
(12) Patent Application Publication
(10) Pub. No.: US 2018/0350523 A1
(43) Pub. Date: Dec. 6, 2018

(54) ROLL-UP CAPACITOR AND METHOD FOR PRODUCING THE SAME

(71) Applicants: Murata Manufacturing Co., Ltd., Nagaokakyo-shi (JP); Leibniz Institute for Solid State and Materials Research Dresden, Dresden (DE)

(72) Inventors: Shoichiro Suzuki, Nagaokakyo-shi (JP); Eric Pankenin, Chemnitz (DE); Oliver G. Schmidt, Dresden (DE)

(21) Appl. No.: 16/047,453

(22) Filed: Jul. 27, 2018

Related U.S. Application Data
(63) Continuation of application No. PCT/JP2016/000586, filed on Feb. 4, 2016.

(51) Int. Cl. H01G 4/32; H01G 4/005; H01G 4/232

(52) U.S. Cl. CPC H01G 4/32; H01G 4/232; H01G 4/005

(57) ABSTRACT

A roll-up type capacitor having at least one cylindrical part, a first external electrode on one end of the cylindrical part and a second external electrode on another end of the cylindrical part. The cylindrical part is formed by rolling-up a lower electrode layer and an upper electrode layer with at least a dielectric layer sandwiched therebetween. The first external electrode is electrically connected to the upper electrode layer, and the second external electrode is electrically connected to the lower electrode layer. A thickness of the upper electrode layer at a part where it is connected to the first external electrode is larger than a thickness of the other part of the upper electrode layer, and/or a thickness of the lower electrode layer at a part where it is connected to the second external electrode is larger than a thickness of the other part of the lower electrode layer.

### CROSS REFERENCE TO RELATED APPLICATIONS

The present application is a continuation of International application No. PCT/JP2016/000586, filed Feb. 4, 2016, the entire contents of which is incorporated herein by reference.

### FIELD OF THE INVENTION

The present invention relates to a capacitor and a method for producing this capacitor, and more particularly to a roll-up type capacitor and a method for producing this roll-up type capacitor.

### BACKGROUND OF THE INVENTION

With development of high-density mounting structure of electronic devices in recent years, demands for a higher-capacitance and smaller-sized capacitor are increasing. An example of this type of capacitor disclosed in Patent Literature 1 is a metallized film capacitor formed by depositing metal material on surfaces of a pair of dielectric films such that a margin part is produced along a side on each of the films to form metallized films, laminating both the metallized films such that the respective margin parts are disposed on the opposite sides, rolling up the laminated films to form a capacitor element, and spraying metal material to both end surfaces of the capacitor element to form external electrodes. Each of the metallized films includes a thin film growth part which contains a thin film produced by nuclear growth of metal particles, and a thin film non-growth part adsorbing metal particles by electrostatic interaction. One end of the thin film non-growth portion contacts the margin part, while the other end contacts the thin film growth part.

Patent Literature 2 discloses a dry metallized film capacitor formed by rolling up a pair of overlapped metallized films, winding a film, which contains an inorganic oxide layer coated with silicon oxide, or silicon oxide and alumina, around the capacitor element, forming an electrode extension part on a rolled-up end surface, and connecting an external terminal to the electrode extension part.

Patent Literature 3 discloses a capacitor producing method which includes a step for forming a laminate on a substrate. The laminate contains at least two electric conductive layers, and at least an electric insulation layer disposed between the two electric conductive layers. The method further includes a step for separating a first part of the laminate from an initial position and shifting the first part. The first portion contains an edge portion of the laminate. The method further includes a step for bending the first part rearward toward a second part of the laminate.

Patent Literature 1: JP 9-162062 A

Patent Literature 2: JP 2002-184642 A

Patent Literature 3: EP 2023357 A

### SUMMARY OF THE INVENTION

According to Patent Literatures 1 and 2, the capacitor is manufactured by rolling up films each having a thickness of several micrometers using a winding machine. In this case, size reduction of the capacitor becomes difficult. According to the roll-up type capacitor disclosed in Patent Literature 3, an electrode terminal connected to an external electric element is formed at a final end of each of rolled first electric conductive layer and second electric conductive layer (hereinafter collectively referred to as “electric conductive layers” as well). In this case, a connection area between the electrode terminal and the electric conductive layer decreases, wherefore electrode resistance increases. Accordingly, equivalent series resistance (ESR) rises, in which condition capacitance in a high frequency range exceeding 100 kHz is difficult to obtain.

The present inventors have found that a roll-up type capacitor capable of decreasing ESR and usable in a preferable condition even in a high frequency range is realizable by producing a cylindrical part from a rolled-up laminate containing a lower electrode layer, a dielectric layer, and an upper electrode layer, and further by providing a pair of external electrodes connecting to other electric elements at one and the other ends of the cylindrical part, respectively. According to the roll-up type capacitor having this structure, bonding property between the lower electrode layer and the external electrode and/or between the upper electrode layer and the external electrode needs to improve so as to increase reliability of the capacitor.

An object of the present invention is to provide a roll-up type capacitor capable of increasing reliability through improvement of bonding property between a lower electrode layer and an external electrode and/or between an upper electrode layer and an external electrode, and to provide a method for producing this roll-up type capacitor.

The present inventors have found that a bonding property between a lower electrode layer and an external electrode and/or between an upper electrode layer and an external electrode improves in a state where the thickness of the upper electrode layer at a part connected to the external electrode is larger than the thickness of the upper electrode layer at the other part, and/or where the thickness of the lower electrode layer at a part connected to the external electrode is larger than the thickness of the lower electrode layer at the other part. The present invention has been developed based on this finding.

A first aspect of the present invention is directed to a roll-up type capacitor comprising at least one cylindrical part, a first external electrode on one end of the cylindrical part and a second external electrode on another end of the cylindrical part. The cylindrical part is formed by rolling up a lower electrode layer and an upper electrode layer with at least a dielectric layer sandwiched therebetween. The first external electrode is electrically connected to the upper electrode layer. The second external electrode is electrically connected to the lower electrode layer. A thickness of the upper electrode layer at a part connected to the first external electrode is larger than a thickness of the other part of the upper electrode layer, and/or a thickness of the lower electrode layer at a part connected to the second external electrode is larger than a thickness of the other part of the lower electrode layer.

A second aspect of the present invention is directed to a method for producing a roll-up type capacitor, the method comprising forming a sacrificial layer on a substrate; forming at least a cylindrical part by forming a laminate including at least a lower electrode layer, an upper electrode layer, and a dielectric layer sandwiched between the lower electrode layer and the upper electrode layer on the sacrificial layer, and rolling up the laminate by removal of the sacrificial layer to obtain the cylindrical part; and forming a first external electrode on one end of the one or more cylindrical part such that the first external electrode is electrically connected to the upper electrode layer, and forming a second external electrode on another end of the one or more cylindrical part such that the second external electrode is electrically connected to the lower electrode layer. An imparting part is formed on the upper electrode layer at a part connected to the first external electrode, and/or an imparting part is formed on the lower electrode layer at a part connected to the second external electrode when forming the laminate.

The present roll-up type capacitor and a method for producing a roll-up type capacitor that are capable of increasing reliability through improvement of a bonding property between a lower electrode layer and an external electrode and/or between an upper electrode layer and an external electrode.

### BRIEF DESCRIPTION OF THE DRAWINGS

FIG. 1(a) is a schematic cross-sectional view of a roll-up type capacitor according to a first embodiment of the present invention along a central axis of a cylindrical part therein. FIG. 1(b) is an exploded perspective view of the roll-up type capacitor of FIG. 1(a). FIG. 1(c) is a schematic cross-sectional view of a variant of the roll-up type capacitor of FIG. 1(a) along a central axis of a cylindrical part therein.

FIG. 2 is a schematic cross-sectional view of a laminate constituting the cylindrical part of the roll-up type capacitor according to the first embodiment perpendicular to the direction of the rolling-up.

FIG. 3 is a schematic cross-sectional view of a first variant of the laminate shown in FIG. 2 perpendicular to the direction of the rolling-up.

FIG. 4 is a schematic cross-sectional view of a second variant of the laminate shown in FIG. 2 perpendicular to the direction of the rolling-up.

FIG. 5 is a schematic cross-sectional view of a third variant of the laminate shown in FIG. 2 perpendicular to the direction of the rolling-up.

FIG. 6 is a schematic cross-sectional view of a fourth variant of the laminate shown in FIG. 2 perpendicular to the direction of the rolling-up.

FIG. 7 is a schematic cross-sectional view of a fifth variant of the laminate shown in FIG. 2 perpendicular to the direction of the rolling-up.

FIG. 8 is a schematic cross-sectional view of a roll-up type capacitor according to a second embodiment along a central axis of a cylindrical part therein.

FIGS. 9(a) to (f) schematically show an example for a method for producing a roll-up type capacitor according to Example 1.

FIG. 10 is a schematic cross-sectional view of a laminate in Example 1 formed on a sacrificial layer perpendicular to the direction of the rolling-up.

FIGS. 11(a) to (d) schematically show an example of a method for producing the roll-up type capacitor according to Example 1.

FIG. 12 is a schematic cross-sectional view of a laminate in Comparative Example 1 formed on a sacrificial layer perpendicular to the direction of the rolling-up.

### DETAILED DESCRIPTION OF THE PREFERRED EMBODIMENTS

A roll-up type capacitor and a method for producing this roll-up type capacitor according to the embodiments of the present invention are hereinafter described in detail with reference to the drawings. Respective shapes, positions and the like of the roll-up type capacitor and respective constituent elements included therein are not limited to specific configurations described and depicted in the following embodiments.

### First Embodiment

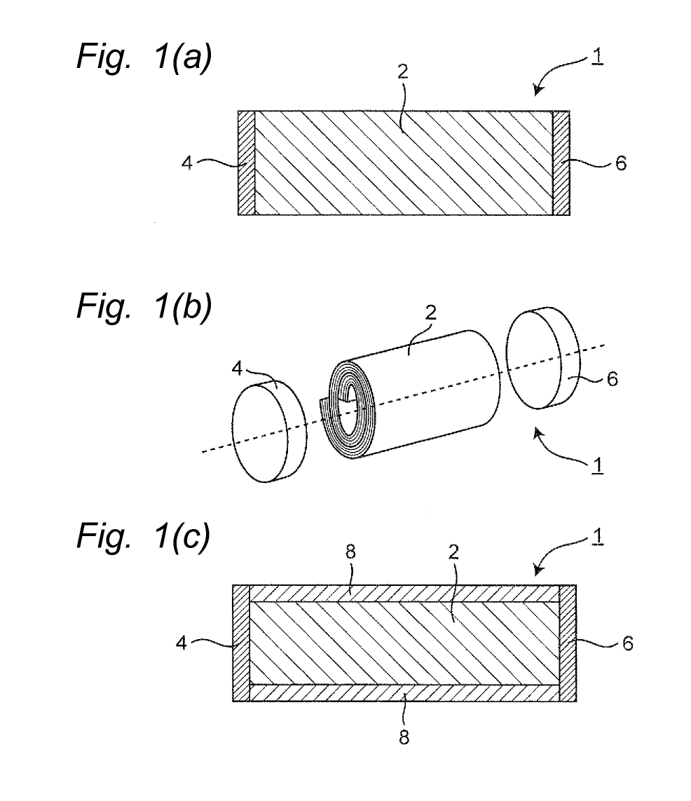

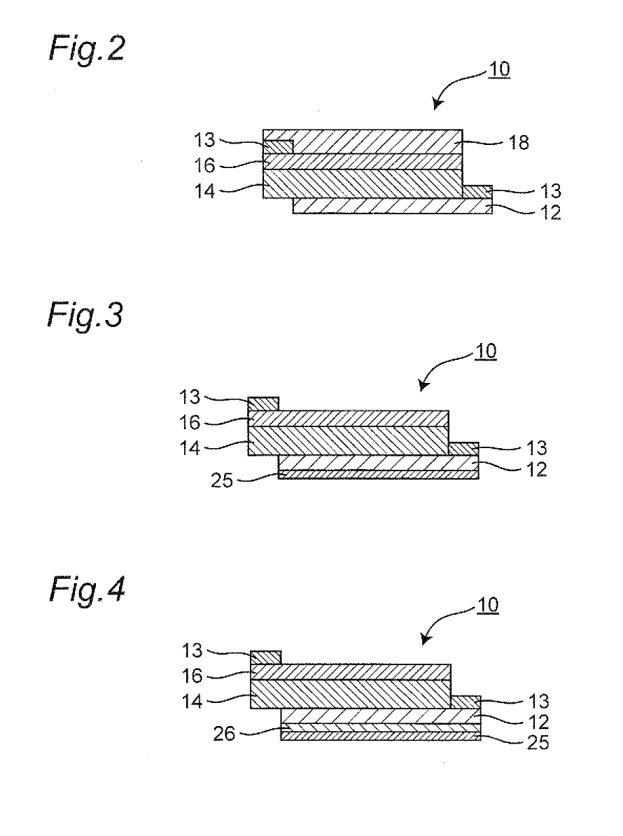

As illustrated in FIGS. 1(a) and 1(b), a roll-up type capacitor 1 according to a first embodiment of the present invention generally includes at least one cylindrical part 2, a first external electrode 4 disposed at one end of the cylindrical part 2, and a second external electrode 6 disposed at the other end of the cylindrical part 2. The first external electrode 4 and the second external electrode 6 disposed at the one and the other end of the cylindrical part 2, respectively, are so positioned as to face each other. The “end” of the cylindrical part 2 in this context refers to an end (or surface) crossing a central axis of the cylindrical part 2. As illustrated in FIG. 1(c), the roll-up type capacitor 1 may include a resin part 8. In this case, the area of the cylindrical part 2 other than both ends thereof is covered by the resin part 8. The cylindrical part 2 is produced by rolling up a lower electrode layer 12 and an upper electrode layer 16 with at least a dielectric layer 14 sandwiched between the lower electrode layer 12 and the upper electrode layer 16. For example, the cylindrical part 2 is produced by rolling up a laminate 10 having a cross-sectional shape illustrated in FIG. 2. According to the laminate 10 illustrated in FIG. 2, the lower electrode layer 12, the dielectric layer 14, and the upper electrode layer 16 are laminated in this order. In the case of the laminate 10 illustrated in FIG. 2, the dielectric layer 14 is not laminated on an imparting part formed on the lower electrode layer 12. However, the present invention is not limited to this specific configuration. The dielectric layer 14 may be laminated on the imparting part 13.

As illustrated in FIG. 2, an insulating layer 18 may be laminated on the upper electrode layer 16, and on the imparting part 13 formed on the upper electrode layer 16 when the imparting part 13 is present thereon. The insulating layer 18 is not an essential element in this embodiment, and thus is not required to be equipped when there is no possibility of electric contact between the lower electrode layer 12 and the upper electrode layer 16.

As illustrated in FIG. 2, the lower electrode layer 12 and the upper electrode layer 16 in the laminate 10 are disposed such that one end of each of the electrode layers 12 and 16 does not overlap with the other electrode layer. The laminate 10 thus constructed is rolled up into the cylindrical part 2 which contains the lower electrode layer 12 and the upper electrode layer 16 with at least the dielectric layer 14 sandwiched therebetween. According to the cylindrical part 2, the first external electrode 4 and the second external electrode 6 are disposed on the left side and the right side, respectively, of the laminate 10 illustrated in FIG. 2. In this arrangement, the upper electrode layer 16 is electrically connected to the first external electrode 4, and electrically separated from the second external electrode 6. Similarly, the lower electrode layer 12 is electrically connected to the second external electrode 6, and electrically separated from the first external electrode 4.

The roll-up type capacitor 1 according to this embodiment achieves considerable size reduction. For example, the diameter of the cylindrical part 2 may be 100 μm or smaller, preferably 50 μm or smaller, and more preferably 20 μm or smaller.

According to the roll-up type capacitor 1 of this embodiment, a thickness of the upper electrode layer 16 at a part connected to the first external electrode 4 is larger than a thickness of the upper electrode layer 16 at the other part, and/or a thickness of the lower electrode layer 12 at a part connected to the second external electrode is larger than a thickness of the lower electrode layer 12 at the other part. In other words, the thickness of at least either the upper electrode layer 16 or the lower electrode layer 12 at the part connected to the external electrode is larger than the thickness of the other part. For example, the thickness of the upper electrode layer 16 and/or the lower electrode layer 12 may be partially increased by forming the imparting part 13 on the upper electrode layer 16 and/or the lower electrode layer 12 as illustrated in FIG. 2. However, the present invention is not limited to this specific configuration. While the imparting part 13 is provided on each of the lower electrode layer 12 and the upper electrode layer 16 in the laminate 10 illustrated in FIG. 2, the present invention is not limited to this specific configuration. The imparting part 13 may be provided only on the lower electrode layer 12, or only on the upper electrode layer 16. When the thickness of at least either the upper electrode layer 16 or the lower electrode layer 12 at the part connected to the external electrode increases in this manner, bonding property between the upper electrode layer and the external electrode and/or between the lower electrode layer 12 and the external electrode improves to such a level that occurrence of poor bonding can decrease. Accordingly, occurrence of open faults decreases, wherefore reliability of the roll-up type capacitor 1 increases. Moreover, ESR of the roll-up type capacitor 1 decreases.

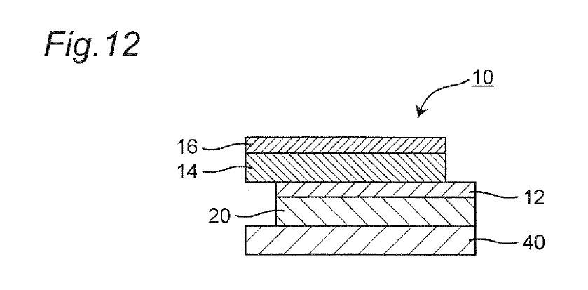

Furthermore, the roll-up type capacitor 1 according to this embodiment offers an advantage of reduction of damage to the laminate 10. As will be described below, the cylindrical part 2 is formed by self-rolling of the laminate 10 by utilizing an internal stress of the laminate 10. More specifically, a roll-up speed of the laminate 10 at a part having a relatively small thickness is higher than a roll-up speed of the laminate 10 at a part having a relatively large thickness. This increase in speed comes from easy bending with a larger stress at the part having the small thickness than at the part having the large thickness in the laminate 10, and with decrease in bending rigidity by reduction in thickness. This difference in the roll-up speed may give damage to the laminate 10. According to the roll-up type capacitor 1 of this embodiment, however, the presence of the imparting part 13 described above decreases the difference in thickness in the laminate 10 in comparison with the laminate 10 illustrated in FIG. 12, for example. Accordingly, damage to the laminate 10 can be suppressed.

The material constituting the lower electrode layer 12 may be an arbitrary material as long as the material has conductivity. For example, the lower electrode layer 12 may be constituted by Ni, Cu, Al, W, Ti, Ag, Au, Pt, Zn, Sn, Pb, Fe, Cr, Mo, Ru, Pd, or Ta, or an alloy of these materials, such as CuNi, AuNi, and AuSn, or metal oxide or metal oxynitride such as TiN, TiAlN, TiON, TiAlON, and TaN.

When the imparting part 13 is provided on the lower electrode layer 12 at the part connected to the second external electrode 6, it is preferable that the imparting part 13 is constituted by the same material as that of the lower electrode layer 12.

The thickness of the lower electrode layer 12 is not particularly limited. It is preferable, however, that the thickness of the lower electrode layer 12 lies in a range from 10 nm to 50 nm (inclusive), for example. When the thickness of the lower electrode layer 12 is increased to 50 nm, for example, ESR can be further decreased. When the thickness of the lower electrode layer 12 is decreased to 10 nm, for example, the diameter of the cylindrical part 2 can be further decreased. In this case, further size reduction of the roll-up type capacitor 1 is achievable.

When the imparting part 13 is provided on the lower electrode layer 12, it is preferable that the thickness of the imparting part 13 is 0.5 times or more of the thickness of the lower electrode layer 12, and does not exceed the thickness of the dielectric layer 14. When the thickness of the imparting part 13 is 0.5 times or more of the thickness of the lower electrode layer 12, bonding property between the lower electrode layer 12 and the second external electrode 6 further improves. Moreover, damage to the laminate 10 further decreases. When the thickness of the imparting part 13 does not exceed the thickness of the dielectric layer 14, short-circuiting is avoidable. It is preferable that the thickness of the imparting part 13 is 0.8 times or less of the thickness of the dielectric layer 14.

The method for producing the lower electrode layer 12 is not particularly limited. The lower electrode layer 12 may be formed directly on a substrate, or on a lower layer formed on the substrate (such as a sacrificial layer described below) when the lower layer is present thereon. Alternatively, the lower electrode layer 12 produced separately may be affixed to the substrate or the lower layer. The lower electrode layer 12 directly provided on the substrate or the layer below the lower electrode layer may be formed by methods such as vacuum deposition, chemical deposition, sputtering, atomic layer deposition (ALD), and pulsed layer deposition (PLD).

When the imparting part 13 is provided on the lower electrode layer 12, the imparting part 13 may be formed by the same method as the forming method of the lower electrode layer 12.

The material constituting the dielectric layer 14 may be an arbitrary material as long as the material has insulation property. Examples of the material constituting the dielectric layer 14 may include: perovskite type complex oxide, aluminum oxide (AlOₓ: such as Al₂O₃), silicon oxide (SiOₓ: such as SiO₂), Al—Ti complex oxide (AlTiOₓ), Si—Ti complex oxide (SiTiOₓ), hafnium oxide (HfOₓ), tantalum oxide (TaOₓ), zirconium oxide (ZrOₓ), Hf—Si complex oxide (HfSiOₓ), Zr—Si complex oxide (ZrSiOₓ), Ti—Zr complex oxide (TiZrOₓ), Ti—Zr—W complex oxide (TiZrWOₓ), titanium oxide (TiOₓ), Sr—Ti complex oxide (SrTiOₓ), Pb—Ti complex oxide (PbTiOₓ), Ba—Ti complex oxide (BaTiOₓ), Ba—Sr—Ti complex oxide (BaSrTiOₓ), Ba—Ca—Ti complex oxide (BaCaTiOₓ), Si—Al complex oxide (SiAlOₓ), and other metal oxides; aluminum nitride (AlN_{y}), silicon nitride (SiN_{y}), Al—Sc complex nitride (AlScN_{y}), and other metal nitrides; and aluminum oxynitride (AlOₓN_{y}), silicon oxynitride (SiOₓN_{y}), Hf—Si complex oxynitride (HfSiOₓN_{y}), Si—C complex oxynitride (SiCzOₓN_{y})ᵣ and other metal oxynitrides. The respective expressions presented above indicate only constitutions of elements, and do not limit compositions of the elements. More specifically, x, y, and z suffixed to O, N, and C may be arbitrary values. Abundance ratios of the respective elements including metal elements are arbitrary ratios. It is preferable that the material has a higher dielectric constant for obtaining higher capacitance. An example of material having a high dielectric constant is perovskite type complex oxide expressed as ABO₃ (A and B: arbitrary metal atoms). A preferable example is perovskite type complex oxide containing titanium (Ti) (hereinafter referred to as “titanium (Ti)-based perovskite type complex oxide” as well). Examples of preferable Ti-based perovskite type complex oxide include BaTiO₃, SrTiO₃, CaTiO₃, (BaSr)TiO₃, (BaCa)TiO₃, (SrCa)TiO₃, Ba(TiZr)O₃, Sr(TiZr)O₃, Ca(TiZr)O₃, (BaSr) (TiZr)O₃, (BaCa) (TiZr)O₃, and (SrCa) (TiZr)O₃. These Ti-based perovskite type complex oxides have high dielectric constants, and thus are advantageous in view of capability of raising capacitance of a capacitor.

The thickness of the dielectric layer 14 is not particularly limited. It is preferable, however, that the thickness of the dielectric layer 14 lies in a range from 1 nm to 50 nm (inclusive), more preferably 10 nm to 100 nm (inclusive), and further preferably in a range from 10 nm to 50 nm (inclusive). When the thickness of the dielectric layer 14 is 10 nm or larger, insulation property can be further improved. In this case, leakage current can be further decreased. When the thickness of the dielectric layer 14 is 100 nm or smaller, capacitance to be obtained can be further increased. When the thickness of the dielectric layer 14 is 100 nm or smaller, the diameter of the cylindrical part 2 can be further decreased. In this case, further size reduction of the roll-up type capacitor 1 is achievable.

The method for producing the dielectric layer 14 is not particularly limited. The dielectric layer 14 may be formed directly on the lower electrode layer 12. Alternatively, the separately produced dielectric layer 14 may be affixed to the lower electrode layer 12. The dielectric layer 14 directly provided on the lower electrode layer 12 may be formed by methods such as vacuum deposition, chemical deposition, sputtering, ALD, and PLD. When the dielectric layer is made of perovskite type complex oxide, the dielectric layer 14 is preferably formed by sputtering.

When the dielectric layer 14 is formed by sputtering, it is preferable that deposition is performed at a substrate temperature in a range from 500° C. to 600° C. (inclusive). When deposition is performed at a high temperature in this range, crystalline of the produced dielectric layer 14 increases. Accordingly, a higher dielectric constant is obtainable. In case of processing at such a high temperature, it is preferable that the laminate 10 contains a diffusion-preventing layer 25 which will be described below.

The material constituting the upper electrode layer 16 may be an arbitrary material as long as the material has conductivity. For example, the material constituting the upper electrode layer 16 is Ni, Cu, Al, W, Ti, Ag, Au, Pt, Zn, Sn, Pb, Fe, Cr, Mo, Ru, Pd, or Ta, an alloy of these materials such as CuNi, AuNi, and AuSn, or metal oxide or metal oxynitride such as TiN, TiAlN, TiON, TiAlON, and TaN.

When the imparting part 13 is provided on the upper electrode layer 16 at the part connected to the first external electrode 4, it is preferable that the imparting part 13 is made of the same material as the material of the upper electrode layer 16.

The thickness of the upper electrode layer 16 is not particularly limited. It is preferable, however, that the thickness of the upper electrode layer 16 lies in a range from 10 nm to 50 nm (inclusive), for example, and more preferably in a range from 10 nm to 30 nm (inclusive). When the thickness of the upper electrode layer 16 is increased to 50 nm, for example, ESR can be further decreased. When the thickness of the upper electrode layer 16 is decreased to 30 nm or smaller, for example, the diameter of the cylindrical part 2 can be further decreased. In this case, further size reduction of the roll-up type capacitor 1 is achievable.

When the imparting part 13 is provided on the upper electrode layer 16, it is preferable that the thickness of the imparting part 13 is 0.5 times or more of the thickness of the upper electrode layer 16. When the thickness of the imparting part 13 is 0.5 times or more of the thickness of the upper electrode layer 16, bonding property between the upper electrode layer 16 and the first external electrode 4 further improves. Moreover, damage to the laminate 10 further decreases. When a second dielectric layer 21 and a third electrode layer 22 are further laminated on the upper electrode layer 16 as illustrated in FIG. 7 referred to below, it is preferable that the thickness of the imparting part 13 does not exceed the thickness of the second dielectric layer 21. When the thickness of the imparting part 13 does not exceed the thickness of the second dielectric layer 21, short-circuiting is avoidable. It is preferable that the thickness of the imparting part 13 is 0.8 times or less of the thickness of the second dielectric layer 21. When the second dielectric layer 21 and the third electrode layer 22 are not laminated on the upper electrode layer 16 as illustrated in FIG. 6 referred to below, it is preferable that the thickness of the imparting part 13 is so determined as not to exceed the sum of the thicknesses of the lower electrode layer 12 and the upper electrode layer 16.

The method for producing the upper electrode layer 16 is not particularly limited. The upper electrode layer 16 may be formed directly on the dielectric layer 14. Alternatively, separately produced the upper electrode layer 16 may be affixed to the dielectric layer 14. The upper electrode layer 16 directly provided on the dielectric layer 14 may be formed by methods such as vacuum deposition, chemical deposition, sputtering, ALD, and PLD.

When the imparting part 13 is provided on the upper electrode layer 16, the imparting part 13 may be formed by the same method as the forming method of the lower electrode layer 12.

The insulating layer 18 may be provided to prevent short-circuiting caused by electric contact between the lower electrode layer 12 and the upper electrode layer 16 when the laminate 10 is rolled up. The insulating layer 18 may also function as a dielectric layer. The material constituting the insulating layer 18 is not particularly limited as long as the material has insulation property. It is preferable, however, that the insulating layer 18 is made of any one of the foregoing examples of the material constituting the dielectric layer 14. When the insulating layer 18 is made of any one of the examples of the material constituting the dielectric layer 14, the function of the insulating layer 18 as a dielectric layer improves. Accordingly, the capacitor exhibiting further increased capacitance can be obtained.

The thickness of the insulating layer 18 is not particularly limited as long as insulation between the lower electrode layer 12 (and the imparting part 13 formed thereon when the imparting part 13 is present) and the upper electrode layer 16 (and the imparting part 13 formed thereon when the imparting part 13 is present) is securable. It is preferable, however, that the thickness of the insulating layer 18 lies in a range from 10 nm to 100 nm (inclusive), for example, and more preferably in a range from 10 nm to 50 nm (inclusive). When the thickness of the insulating layer 18 is 10 nm or larger, insulation property increases. In this case, leakage current further decreases. When the thickness of the insulating layer 18 is 100 nm or smaller, the diameter of the cylindrical part 2 further decreases. In this case, further size reduction of the capacitor is achievable.

The method for producing the insulating layer 18 is not particularly limited. The insulating layer 18 may be formed directly on the upper electrode layer 16. Alternatively, separately produced the insulating layer 18 may be affixed to the upper electrode layer 16. The insulating layer 18 directly provided on the upper electrode layer 16 may be formed by methods such as vacuum deposition, chemical deposition, sputtering, ALD, and PLD. When the insulating layer is made of perovskite type complex oxide, the insulating layer is preferably formed by sputtering.

Each of the materials constituting the first external electrode 4 and the second external electrode 6 may be an arbitrary material as long as the material has conductivity. Examples of the material constituting the first external electrode 4 and the second external electrode 6 include Ag, Cu, Pt, Ni, Al, Pd, and Au, and alloys of these materials such as monel (Ni—Cu alloy).

The method for producing the first external electrode 4 and the second external electrode 6 is not particularly limited. Examples of this method include plating, deposition, and sputtering.

According to the roll-up type capacitor 1 of this embodiment, the cylindrical part 2 may be surrounded by and embedded in the resin part 8 as illustrated in FIG. 1(c). In this case, the area of the cylindrical part 2 other than both ends thereof is covered by the resin part 8. The resin part 8 is provided to protect the cylindrical part 2, and to allow easy handling of the cylindrical part 2. Resin forming the resin part 8 may permeate into the cylindrical part 2. The cylindrical part 2 into which resin is impregnated is hardened with the resin, in which condition the properties of the capacitor are further stabilized. The resin part 8 is not an essential component. The roll-up type capacitor 1 according to this embodiment functions even when the resin part 8 is absent.

The material constituting the resin part 8 may be an arbitrary material as long as the material has insulation property. The resin part 8 may be made of acrylic resin, epoxy, polyester, silicone, polyurethane, polyethylene, polypropylene, polystyrene, nylon, polycarbonate, polybutylene terephthalate or the like. The resin part 8 may contain insulating substances as fillers to increase strength.

According to the roll-up type capacitor of this embodiment described herein, the cross-sectional area of each of the upper electrode layer 16 and the lower electrode layer 12 at the part connected to the external electrode increases. Accordingly, reduction of ESR, and high capacitance even in a high frequency range are both realizable. Moreover, according to the roll-up type capacitor of this embodiment, current linearly flows in a direction along the central axis of the cylindrical part. Accordingly, the roll-up type capacitor of this embodiment is more appropriate for use in a high frequency range in comparison with a conventional roll-up type capacitor where current flows in a coil shape along a rolling direction.

FIG. 3 illustrates a first modified example of the laminate 10 according to this embodiment. As illustrated in FIG. 3, the diffusion-preventing layer 25 may be further provided below the lower electrode layer 12. The diffusion-preventing layer 25 thus provided prevents diffusion of components constituting the sacrificial layer (described below) toward the lower electrode layer 12 at the time of manufacture of the roll-up type capacitor. When a second insulating layer 20 is further laminated below the lower electrode layer 12 as illustrated in FIG. 6 referred to below, the diffusion-preventing layer 25 may be laminated below the second insulating layer 20.

The material constituting the diffusion-preventing layer 25 is not particularly limited. Preferable examples of the material constituting the diffusion-preventing layer may include: aluminum oxide (AlOₓ: such as Al₂O₃), silicon oxide (SiOₓ: such as SiO₂), Al—Ti complex oxide (AlTiOₓ), Si—Ti complex oxide (SiTiOₓ), hafnium oxide (HfOₓ), tantalum oxide (TaOₓ), zirconium oxide (ZrOₓ), Hf—Si complex oxide (HfSiOₓ), Zr—Si complex oxide (ZrSiOₓ), Ti—Zr complex oxide (TiZrOₓ), Ti—Zr—W complex oxide (TiZrWOₓ), titanium oxide (TiOₓ), Sr—Ti complex oxide (SrTiOₓ), Pb—Ti complex oxide (PbTiOₓ), Ba—Ti complex oxide (BaTiOₓ), Ba—Sr—Ti complex oxide (BaSrTiOₓ), Ba—Ca—Ti complex oxide (BaCaTiOₓ), Si—Al complex oxide (SiAlOₓ), Sr—Ru complex oxide (SrRuOₓ), Sr—V complex oxide (SrVOₓ), and other metal oxides; aluminum nitride (AlN_{y}), silicon nitride (SiN_{y}), Al—Sc complex nitride (AlScN_{y}), titanium nitride (TiN_{y}), and other metal nitrides; and aluminum oxynitride (AlOₓN_{y}), silicon oxynitride (SiOₓN_{y}), Hf—Si complex oxynitride (HfSiOₓN_{y}), Si—C complex oxynitride (SiCzOₓN_{y})ᵣ and other metal oxynitrides, and particularly preferably AlOₓ and SiOₓ. The respective expressions presented above indicate only constitutions of elements, and do not limit compositions of the elements. More specifically, x, y, and z suffixed to O, N, and C may be arbitrary values. Abundance ratios of the respective elements including metal elements are arbitrary ratios.

The thickness of the diffusion-preventing layer 25 is not particularly limited. It is preferable, however, that the thickness of the diffusion-preventing layer 25 lies in a range from 5 nm to 30 nm (inclusive), for example, and more preferably in a range from 5 nm to 10 nm (inclusive). When the thickness of the diffusion-preventing layer 25 is 5 nm or larger, diffusion of components constituting the sacrificial layer can more effectively decrease. When the diffusion-preventing layer 25 is made of insulating material, insulation property improves. Accordingly, leakage current decreases. When the thickness of the diffusion-preventing layer 25 is 30 nm or smaller, particularly 10 nm or smaller, the diameter of the cylindrical part 2 further decreases. In this case, further size reduction of the roll-up type capacitor 1 is achievable. Moreover, the roll-up type capacitor exhibiting further increased capacitance can be obtained.

The diffusion-preventing layer 25 may be formed by vacuum deposition, chemical deposition, sputtering, ALD, PLD, or other methods. In these methods, ALD is more preferable. The method of ALD forms a film by depositing atomic layers one by one by using reaction gas which contains material constituting the layers. Accordingly, ALD produces an extremely uniform and fine film. The diffusion-preventing layer 25 formed on the sacrificial layer by ALD is capable of effectively reducing diffusion of the components constituting the sacrificial layer toward other layers, such as the lower electrode layer 12. Moreover, the extremely thin, uniform, and fine diffusion-preventing layer 25 formed by ALD becomes a film capable of decreasing leakage current and offering high insulation property when the diffusion-preventing layer 25 is made of insulating material. A film formed by ALD is generally amorphous. Accordingly, the composition ratio of the film is not limited to a stoichiometric ratio, but may be other various composition ratios.

When the diffusion-preventing layer 25 is made of insulating material, electric contact between the upper electrode layer 16 and the lower electrode layer 12 is avoidable in the cylindrical part 2 produced from the rolled-up laminate 10 by the presence of the diffusion-preventing layer 25. In this case, the insulating layer 18 discussed above is unnecessary.

FIG. 4 illustrates a second modified example of the laminate 10 according to this embodiment. As illustrated in FIG. 4, an adhering layer 26 may be further laminated between the diffusion-preventing layer 25 and the lower electrode layer 12. The adhering layer 26 has a function of adhering to the diffusion-preventing layer 25 and the lower electrode layer 12 to prevent separation of the lower electrode layer 12 from the laminate 10. When the second insulating layer 20 is further laminated below the lower electrode layer 12 as illustrated in FIG. 6 referred to below, the adhering layer 26 may be laminated between the second insulating layer 20 and the diffusion-preventing layer 25.

The material constituting the adhering layer 26 may be titanium oxide (TiOₓ) or chromium oxide (CrOₓ), for example.

The method for producing the adhering layer 26 is not particularly limited. For example, the adhering layer 26 may be formed directly on a layer present below the adhering layer 26 (such as sacrificial layer). Alternatively, the adhering layer 26 separately produced may be affixed to the layer present below the adhering layer 26. The adhering layer 26 provided directly on the layer present below the adhering layer 26 may be formed by vacuum deposition, chemical deposition, sputtering, ALD, PLD, or other methods.

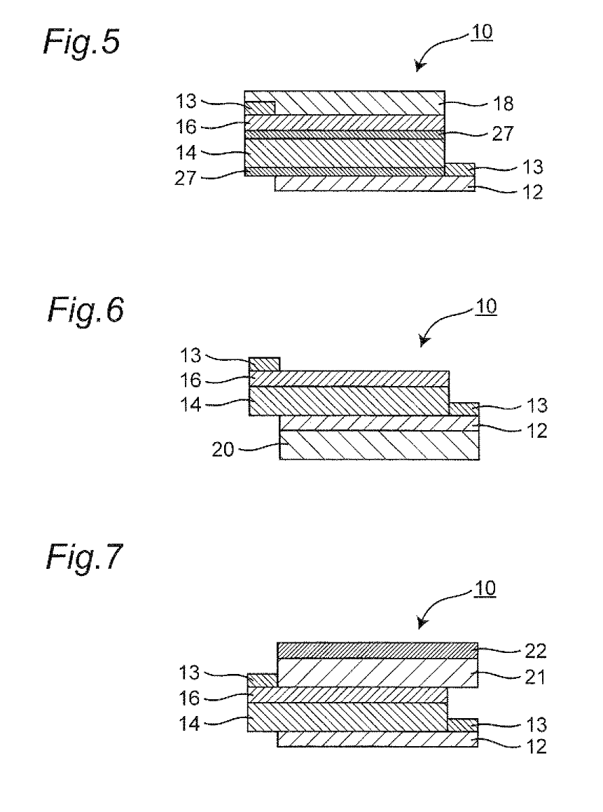

FIG. 5 illustrates a third modified example of the laminate 10 according to this embodiment. As illustrated in FIG. 5, an interfacial layer 27 may be further laminated between the dielectric layer 14 and the upper electrode layer 16, and/or between the dielectric layer 14 and the lower electrode layer 12. The interfacial layer 27 has a function of reducing leakage current produced by Schottky junction. When the second insulating layer 20 is further laminated below the lower electrode layer 12 as illustrated in FIG. 6 referred to below, the interfacial layer 27 may be further laminated between the second insulating layer 20 and the lower electrode layer 12. When the second dielectric layer 21 and the third electrode layer 22 are further laminated in this order on the upper electrode layer 16 as illustrated in FIG. 7 referred to below, the interfacial layer 27 may be further laminated between the second dielectric layer 21 and the upper electrode layer 16 and/or between the second dielectric layer 21 and the third electrode layer 22.

According to the laminate 10 illustrated in FIG. 5, the insulating layer 18 is laminated on the upper electrode layer 16 and on the imparting part 13 formed on the upper electrode layer 16. However, the insulating layer 18 is not an essential constituent element in this embodiment, and not required to be equipped when there is no possibility of electric contact between the lower electrode layer 12 and the upper electrode layer 16.

The material constituting the interfacial layer 27 may be arbitrary metal appropriate for the material of the dielectric layer.

The method for producing the interfacial layer 27 is not particularly limited. For example, the interfacial layer 27 may be formed directly on a layer present below the interfacial layer 27. Alternatively, the interfacial layer 27 separately produced may be affixed to the layer present below the interfacial layer 27. The interfacial layer 27 provided directly on the layer present below the interfacial layer 27 may be formed by vacuum deposition, chemical deposition, sputtering, ALD, PLD, or other methods.

FIG. 6 illustrates a fourth modified example of the laminate 10 according to this embodiment. As illustrated in FIG. 6, another insulating layer (referred to as second insulating layer 20 as well) may be further laminated below the lower electrode layer 12. When the second insulating layer 20 is laminated in this manner, electric contact between the upper electrode layer 16 and the lower electrode layer 12 is avoidable by the presence of the second insulating layer 20 in the cylindrical part 2 produced from the rolled-up laminate 10. In this case, the insulating layer 18 discussed above is unnecessary. According to the modified example illustrated in FIG. 6, the imparting part 13 is provided on the upper electrode layer 16 and on the lower electrode layer 12. However, the present invention is not limited to this specific configuration. The imparting part 13 may be provided only on either the upper electrode layer 16 or the lower electrode layer 12. The second insulating layer 20 may function as a dielectric layer.

The material constituting the second insulating layer 20 may be any one of the foregoing examples of the material constituting the dielectric layer 14. The method for producing the second insulating layer 20 may be any one of the foregoing examples of the method for producing the dielectric layer 14. The laminate 10 illustrated in FIG. 6 contains a smaller number of constituent elements, wherefore the entire thickness of the laminate 10, and thus the flexural rigidity of the laminate 10 decrease. As a result, an advantage of diameter reduction of the cylindrical part 2 is realizable.

FIG. 7 illustrates a fifth modified example of the laminate 10 according to this embodiment. As illustrated in FIG. 7, another dielectric layer (referred to as second dielectric layer 21 as well), and another electrode layer (referred to as third electrode layer 22 as well) are further laminated in this order on the upper electrode layer 16. The laminate illustrated in FIG. 7 contains the three electrode layers 12, 16, and 22, and the dielectric layers 14 and 21 provided between the electrode layers 12 and 16, and between the electrode layers 16 and 22, respectively. However, the present invention is not limited to this specific configuration. The laminate may contain four or more electrode layers and dielectric layers provided therebetween. According to the laminate 10 illustrated in FIG. 7, the second dielectric layer 21 is not laminated on the imparting part 13 provided on the upper electrode layer 16. However, the present invention is not limited to this specific configuration. The second dielectric layer 21 may be laminated on the imparting part 13. The third electrode layer 22 is disposed in such a position not completely overlapping with the upper electrode layer 16 similarly to the lower electrode layer 12. In this case, the third electrode layer 22 is electrically connected to the second external electrode 6, and electrically separated from the first external electrode 4. When the second dielectric layer 21 and the third electrode layer 22 are laminated in this condition, electric contact between the upper electrode layer 16 and the lower electrode layer 12 is avoidable in the cylindrical part 2 produced from the rolled-up laminate 10. Accordingly, the insulating layer 18 discussed above is unnecessary. According to the modified example illustrated in FIG. 7, the imparting part 13 is provided on the upper electrode layer 16 and on the lower electrode layer 12. However, the present invention is not limited to this specific configuration. The imparting part 13 may be provided only on either the upper electrode layer 16 or the lower electrode layer 12. In addition, while the imparting part is not provided on the third electrode layer 22 according to the modified example illustrated in FIG. 7, the present invention is not limited to this specific configuration. The imparting part may be provided on the third electrode layer 22. The laminate 10 illustrated in FIG. 7 as a laminate containing the lower electrode layer 12 and the third electrode layer 22 offers an advantage of securely obtaining capacitance corresponding to two layers (dielectric layer 14 and second dielectric layer 21).

The material constituting the second dielectric layer 21 may be any one of the foregoing examples of the material constituting the dielectric layer 14. The method for producing the second dielectric layer 21 may be any one of the foregoing examples of the method for producing the dielectric layer 14.

The material constituting the third electrode layer 22 may be any one of the foregoing examples of the material constituting the lower electrode layer 12. The method for producing the third electrode layer 22 may be any one of the foregoing examples of the method for producing the lower electrode layer 12.

The roll-up type capacitor according to the present invention is not limited to the capacitor described in the embodiment herein, but may be modified in various ways as long as the function as the capacitor is offered. For example, a plurality of identical layers, or additional layers may be formed.

A method for producing the roll-up type capacitor according to the first embodiment of the present invention is hereinafter described. The method for producing the roll-up type capacitor according to the present invention is not limited to the method described herein.

The roll-up type capacitor according to this embodiment is generally manufactured by forming a sacrificial layer on a substrate; forming at least a cylindrical part by forming a laminate including at least a lower electrode layer, an upper electrode layer, and a dielectric layer sandwiched between the lower electrode layer and the upper electrode layer on the sacrificial layer, and rolling up the laminate by removal of the sacrificial layer to obtain the cylindrical part; and forming a first external electrode on one end of the one or more cylindrical part such that the first external electrode is electrically connected to the upper electrode layer, and forming a second external electrode on another end of the one or more cylindrical part such that the second external electrode is electrically connected to the lower electrode layer. In the step for forming the laminate, an imparting part is formed on the upper electrode layer at a part connected to the first external electrode, and/or an imparting part is formed on the lower electrode layer at a part connected to the second external electrode. The imparting part thus formed improves bonding property between the lower electrode layer and the external electrode and/or between the upper electrode layer and the external electrode. Moreover, damage to the laminate is avoidable. More specifically, the roll-up type capacitor according to this embodiment is manufactured by the method described below.

Initially, a substrate is prepared.

The material constituting the substrate is not particularly limited. It is preferable, however, that the substrate is made of such a material not adversely affecting deposition of a sacrificial layer, and stable for etchant used for removal of the sacrificial layer. Examples of the material constituting the substrate include silicon, silica, and magnesia. The substrate may be in the form of foil or flexible substrate.

Then, a sacrificial layer is formed on the substrate.

The material constituting the sacrificial layer may be an arbitrary material as long as the material is able to release a laminate described below by etching or other methods after formation of the laminate. Preferably, the material is a material removable by etching. The sacrificial layer is preferably made of germanium oxide which is relatively stable at a high temperature.

The thickness of the sacrificial layer is not particularly limited. For example, the thickness of the sacrificial layer lies in a range from 5 nm to 100 nm (inclusive), and more preferably in a range from 10 nm to 30 nm (inclusive).

The method for forming the sacrificial layer is not particularly limited. The sacrificial layer may be formed directly on the substrate. Alternatively, a film separately produced may be affixed to the substrate. The sacrificial layer provided directly on the substrate may be formed by vacuum deposition, chemical deposition, sputtering, PLD or other methods.

Instead, the sacrificial layer may be formed by processing a precursor layer formed on the substrate. For example, a metal layer may be formed and oxidized on the substrate to produce the sacrificial layer.

Subsequently, a laminate which contains at least a lower electrode layer, an upper electrode layer, and a dielectric layer sandwiched between the lower electrode layer and the upper electrode layer is formed on the sacrificial layer. The step for forming the laminate may include forming the lower electrode layer, the dielectric layer, and the upper electrode layer in this order by the method described above. The number of the laminate is not limited to one for the one substrate. A plurality of the laminates may be formed on the one substrate at the same time. When the roll-up type capacitor includes other layers such as an insulating layer, a diffusion-preventing layer, an adhering layer, a second dielectric layer, and a third electrode layer, these layers may be formed at desired positions to manufacture the laminate.

More specifically, the method for producing the roll-up type capacitor according to this embodiment may include a step for forming an insulating layer on the upper electrode layer and on an imparting part formed thereon when present, for example. The method may include a step for forming a diffusion-preventing layer before forming the lower electrode layer. When the step for forming the diffusion-preventing layer is present, the method may include a step for forming an adhering layer between the diffusion-preventing layer and the lower electrode layer. The method may further include a step for forming an interfacial layer between the dielectric layer and the upper electrode layer, and/or between the dielectric layer and the lower electrode layer.

The method may further include a step for forming another insulating layer (second insulating layer) before forming the lower electrode layer. The method may further include a step for forming another dielectric layer (second dielectric layer) and another electrode layer (third electrode layer) on the upper electrode layer.

In the step for forming the laminate, the method forms the imparting part on the upper electrode layer at a part connected to the first external electrode by the method described above, and/or the imparting part on the lower electrode layer at a part connected to the second external electrode by the method described above. When the laminate includes an additional electrode layer (third electrode layer or the like) as well as the upper electrode layer and the lower electrode layer, the imparting part may be formed on the additional electrode layer.

According to the foregoing laminate, the lower electrode layer and the upper electrode layer are disposed such that one end of each of the lower electrode layer and the upper electrode layer does not overlap with the other electrode layer as illustrated in FIG. 2, for example. The laminate having this structure may be manufactured by using a metal mask (metallic mask), for example, or by using a photolithography technique.

The entire laminate discussed above has an internal stress directed from the lower electrode layer to the upper electrode layer. This internal stress is generated by applying a tensile stress to a layer in the lower region of the laminate, such as the lower electrode layer, and/or applying a compressive stress to a layer in the upper region of the laminate, such as the upper electrode layer. It is preferable that the laminate is formed such that the lower electrode layer has a tensile stress, and that the upper electrode layer has a compressive stress. The material and the forming method of the layer receiving a tensile stress or a compressive stress may be appropriately selected by those skilled in the art.

The laminate is separated from the substrate by the internal stress generated in the laminate in the direction from the lower electrode layer to the upper electrode layer. Then, the laminate can be bended and self-rolled by the internal stress.

The laminate obtained in the foregoing manner is rolled up by cracking the bonds which hold the laminate on the substrate and releasing the laminate from the substrate. For example, the laminate obtained in the foregoing manner is rolled up by removal of the sacrificial layer.

The method for removing the sacrificial layer is not particularly limited. It is preferable, however, that the sacrificial layer is etched using etchant. For example, the sacrificial layer or the substrate is exposed by etching or other methods at the starting portion of the rolling of the laminate. Etchant is poured through the exposed portion, and then the sacrificial layer can be etched to be removed.

The etchant may be appropriately selected in accordance with the material constituting the sacrificial layer and the layers forming the laminate. When the sacrificial layer is made of GeO₂, for example, hydrogen peroxide solution is preferably used as etchant.

The sacrificial layer is gradually removed from one end of the laminate. The laminate is sequentially separated from the substrate such that the separation of the laminate starts from the removed portion of the sacrificial layer. The separated laminate is bended and rolled by the internal stress of the laminate, and thus formed into a cylindrical part. The number of windings of the cylindrical part is not particularly limited, i.e., may be either one or plural. The number of windings of the cylindrical part is appropriately determined in accordance with desired size (diameter) and capacitance of the roll-up type capacitor to be produced.

Then, a first external electrode and a second external electrode are formed at one and the other end of the obtained cylindrical part, respectively, by the method described above such as plating.

The roll-up type capacitor according to this embodiment is now completed.

It is preferable that the method for producing the roll-up type capacitor according to this embodiment further includes a step for hardening the cylindrical part with a resin before forming the first external electrode and the second electrode. More specifically, the cylindrical part produced by rolling up the laminate may be immersed in the resin poured into the substrate on which the cylindrical part is disposed, for example. It is preferable that immersion is carried out for a time sufficient for impregnation of the resin into the cylindrical part.

After the resin is hardened, the cylindrical part is cut into a desired shape such as a rectangular parallelepiped shape. The upper electrode layer and the lower electrode layer are exposed on the surfaces of the cylindrical part at both ends thereof by polishing or other methods. Subsequently, the first external electrode and the second external electrode are formed on the surfaces on which the upper electrode layer and the lower electrode layer are exposed, respectively, to produce a roll-up type capacitor including the cylindrical part surrounded by and embedded in the resin part.

### Second Embodiment

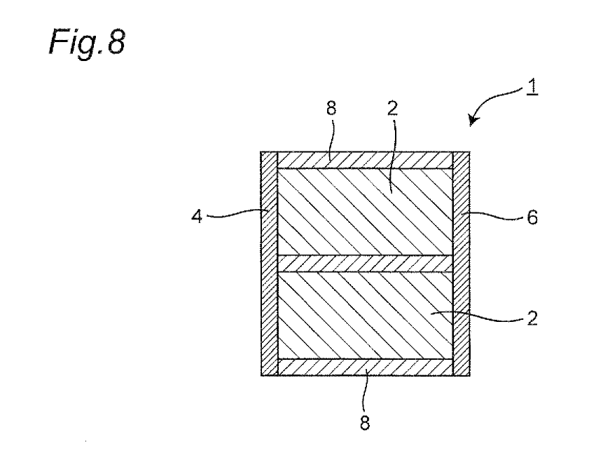

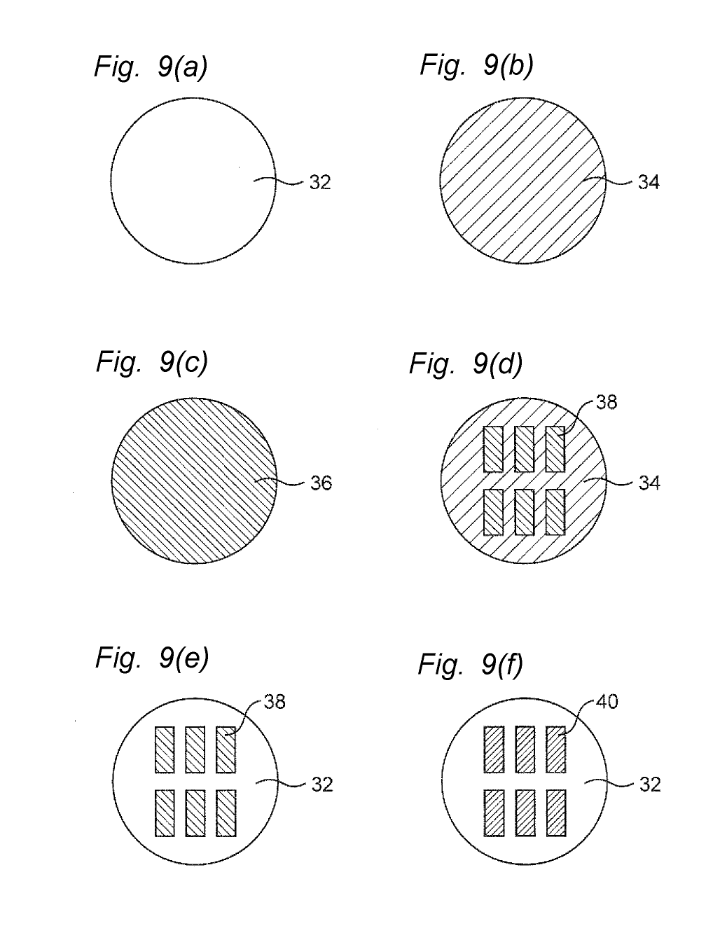

A roll-up type capacitor according to a second embodiment of the present invention is hereinafter described with reference to FIG. 8. Points in the second embodiment similar to the corresponding points in the first embodiment are not repeated herein. Only different points are touched upon. Particularly, each of advantageous effects offered by similar configurations is not again described in this embodiment. It is assumed, however, that the roll-up type capacitor according to the second embodiment offers advantageous effects similar to the advantageous effects of the roll-up type capacitor of the first embodiment unless specified otherwise. The roll-up type capacitor according to the second embodiment has a structure similar to the structure of the roll-up type capacitor according to the first embodiment except in that the two or more cylindrical parts 2 are provided in parallel. The state that “the two or more cylindrical parts 2 are provided in parallel” in this context refers to such a state that the center axes of the two or more cylindrical parts are arranged in parallel with each other. While the roll-up type capacitor 1 illustrated in FIG. 8 includes the two cylindrical parts 2, the present invention is not limited to this specific configuration. The roll-up type capacitor may include three or more cylindrical parts. The first external electrode 4 is disposed at one end of each of the foregoing two or more cylindrical parts 2, while the second external electrode 6 is disposed at the other end thereof. Each of the two or more cylindrical parts 2 includes a lower electrode layer, a dielectric layer, and an upper electrode layer. The first external electrode 4 is electrically connected with each of the upper electrode layers, while the second external electrode 6 is electrically connected with each of the lower electrode layers. The shape of the roll-up type capacitor 1 according to this embodiment is not particularly limited. For example, the roll-up type capacitor 1 may be a plate-type capacitor.

The roll-up type capacitor according to this embodiment includes the two or more cylindrical parts 2 disposed in parallel, and thus obtains higher capacitance than a roll-up type capacitor including only one cylindrical part having the same length. Moreover, the roll-up type capacitor including the two cylindrical parts in parallel having the half length obtains equivalent capacitance, and decreases ESR in comparison with the roll-up type capacitor including only one cylindrical part. Furthermore, the roll-up type capacitor in this embodiment is capable of obtaining capacitance in a higher frequency range.

The roll-up type capacitor according to the second embodiment is produced by a method similar to the method for producing the roll-up type capacitor according to the first embodiment. In this case, the two or more cylindrical parts arranged in parallel may be hardened with resin in the step for hardening the resin.

### Example 1

A roll-up type capacitor according to Example 1 is produced by the following procedures.

(Formation of Sacrificial Layer Pattern)

A circular Si monocrystal substrate having a diameter of 4 inches (10.16 cm) was prepared as a substrate 32 (FIG. 9(a)). A Ge layer having a thickness of 50 nm was formed on the entire surface of the substrate 32 by sputtering. The Ge layer thus obtained was oxidized at 150° C. under an atmosphere of N₂/O₂ to form a sacrificial layer 34 made of GeO₂ (FIG. 9(b)). A positive-type photoresist 36 was applied to the entire surface of the sacrificial layer 34 (FIG. 9(c)). Then, a photoresist pattern 38 containing arrangement of hardened strip-shaped photoresists on the sacrificial layer 34 was produced by removing a non-hardened portion after ultraviolet exposure via a mask having a predetermined pattern and development (FIG. 9(d)). The substrate 32 thus formed was immersed in etchant containing hydrogen peroxide solution to remove the sacrificial layer 34 in a part other than a part where the hardened photoresist pattern 38 was formed (FIG. 9(e)). Subsequently, the hardened photoresist pattern 38 was removed by using acetone to produce a sacrificial layer pattern 40 containing arrangement of strip-shaped sacrificial layers each of which has a width of 500 μm and a length of 1 mm (FIG. 9(f)).

(Formation of Laminate)

A metal mask containing arrangement of strip-shaped patterns each of which has a width of 500 μm and a length of 1 mm was placed on the substrate obtained by the foregoing procedures. One SiO₂ layer corresponding to the second insulating layer 20, and one Pt layer corresponding to the lower electrode layer 12 were formed on the sacrificial layer pattern 40 in this order. Then, the metal mask was shifted by 50 μm in a direction perpendicular to the longer side of the strip-shaped pattern to form one SiO₂ layer corresponding to the dielectric layer 14, and one Pt layer corresponding to the upper electrode layer 16. The SiO₂ layer was formed by ALD at 230° C., while the Pt layer was formed by sputtering at 230° C. The thickness of each of the SiO₂ layers (dielectric layer 14 and the second insulating layer 20) was 50 nm, while the thickness of each of the Pt layers (lower electrode layer 12 and upper electrode layer 16) was 25 nm. Each of the lower electrode layer 12 and the upper electrode layer 16 contained an area of 50 μm in length in the width direction as an area not overlapping with each other in the plan view.

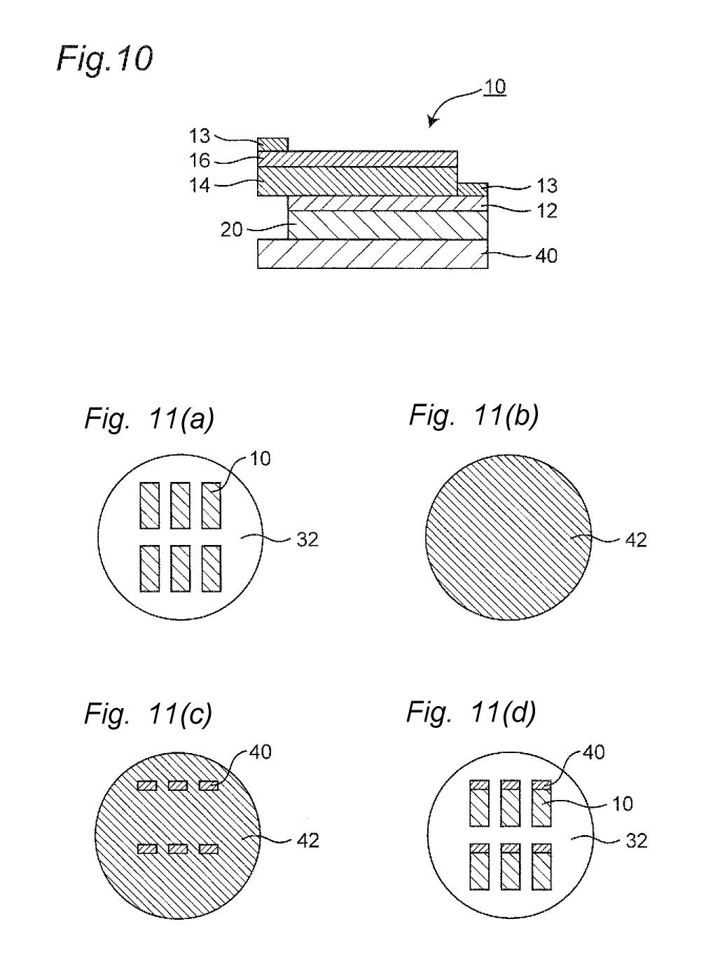

Another metal mask containing arrangement of strip-shaped patterns each of which has a width of 50 μm and a length of 1 mm was placed on the substrate containing the SiO₂ layers and the Pt layers thus formed. A Pt layer corresponding to the imparting part 13 was formed on each of the lower electrode layer 12 and the upper electrode layer 16 by sputtering or deposition. The thickness of the Pt layer (imparting part 13) was 25 nm. The rectangular laminate 10 having a cross-sectional shape illustrated in FIG. 10 was thus formed on the sacrificial layer pattern 40.

(Formation of Cylindrical Part (Rolling Up Step))

A photoresist 42 was applied (FIG. 11(b)) to the entire surface of the substrate 32 containing arrangement of a plurality of the laminates 10 thus obtained (FIG. 11(a)). The photoresist 42 on one short side of each of the laminates 10 was removed by patterning. Then, the part from which the photoresist 42 had been removed was etched by using hydrofluoric acid solution to remove a part of each of the laminates 10 and expose the sacrificial layer 40 (FIG. 11(c)). Then, the photoresist 42 was removed (FIG. 11(d)). Hydrogen peroxide solution was supplied to the part through which the sacrificial layer 40 was exposed to gradually etch the sacrificial layer 40 from one short side of each of the laminates 10. Each of the laminates 10 was rolled up in accordance with etching of the sacrificial layer 40. The cylindrical parts 2 (capacitor bodies) each having a diameter of 50 μm and a length of 500 μm were produced by these procedures.

(Formation of Resin Part (Resin Hardening Step))

A dam was formed on an outer edge portion of the substrate where the capacitor bodies had been produced in the manner described above. Epoxy resin was poured into the dam, and the capacitor bodies were immersed into the epoxy resin. Then, air contained in the epoxy resin was removed by vacuum heating, whereafter the resin was impregnated into the capacitor bodies for five minutes. After an elapse of this period, the substrate was stored in an oven heated to 150° C. for a whole day and night to thermally harden the epoxy resin. The hardened epoxy resin and substrate were rapidly cooled approximately to room temperature to separate the resin containing the capacitor bodies by utilizing a stress difference between the substrate and the resin. Then, epoxy resin was further applied to a separated portion of the resin, and thermally hardened in a similar manner to seal the capacitor bodies.

(Formation of External Electrode)

The resin containing the capacitor bodies produced by the foregoing procedures was cut by a dicer into units each containing the capacitor body. Then, resin parts provided at both ends of the capacitor body were polished to expose the lower electrode layer on one of the end surfaces, and the upper electrode layer on the other end surface. The first external electrode 4 and the second external electrode 6 were formed by electroplating (Ni plating) on the corresponding exposed end surfaces (exposure surfaces), respectively. The upper electrode layer 16 was connected to the first external electrode 4, while the lower electrode layer 12 was connected to the second external electrode 6. The roll-up type capacitor 1 according to Example 1 thus obtained had a cross-sectional shape illustrated in FIG. 1(c).

### Comparative Example 1

A roll-up type capacitor according to Comparative Example 1 was produced by procedures similar to the procedures of Example 1 except that the imparting part 13 was not formed. The laminate 10 used in Comparative Example 1 had a cross-sectional shape illustrated in FIG. 12. FIG. 12 illustrates a cross section of the laminate 10 formed on the sacrificial layer pattern 40.

(Measurement of Capacitance and ESR)

The 30 roll-up type capacitors according to Example 1, and the 30 roll-up type capacitors according to Comparative Example 1 were prepared. Alternating current voltage of 100 mV in a range from 1 MHz to 100 MHz was applied to each of the roll-up type capacitors to measure capacitance C, tan δ, and resistance r. Based on the measured values of C, tan δ, and r, ESR was calculated by using the following equation.

ESR=r+tan δ/ωC

According to the calculation results, capacitance of 1 nF was obtained for all of the 30 roll-up type capacitors in the entire frequency range from 1 MHz to 100 MHz. In addition, ESR at 100 MHz was calculated from an equation of ESR=r+tan δ/ωC based on the measured values of C, tan δ, and r for all of the 30 roll-up type capacitors. The calculated ESR was 5Ω (100 MHz). Based on the foregoing results, it has been confirmed that connection between the upper electrode layer and the first external electrode, and connection between the lower electrode layer and the second external electrode were both preferable in the roll-up type capacitor according to Example 1.

As for Comparative Example 1, capacitance of 1 nF was obtained for only the 20 capacitors of the 30 roll-up type capacitors in the frequency range from 1 MHz to 100 MHz. Capacitance was not obtained for the remaining 10 roll-up type capacitors. The ESR of the 20 samples having obtained capacitance was 10Ω. Based on the foregoing results, it is considered that poor connection was caused between the upper electrode layer and the first external electrode, and between the lower electrode layer and the second external electrode.

### Example 2

A roll-up type capacitor according to Example 2 was prepared by the following procedures. Initially, the cylindrical part 2 (capacitor body) having a diameter of 50 μm and a length of 250 μm was produced by procedures similar to the procedures of Example 1 except that a strip-shaped pattern of a metal mask used for forming the lower electrode layer 12, the upper electrode layer 16, the dielectric layer 14, and the second insulating layer 20 had a width of 250 μm. The two capacitor bodies thus formed were arranged in parallel on the substrate. A dam was formed on the substrate. Epoxy resin was poured into the dam, and the capacitor bodies were immersed in the epoxy resin. Then, air contained in the epoxy resin was removed by vacuum heating, whereafter the resin was impregnated into the capacitor bodies for five minutes. After an elapse of this period, the substrate was stored in an oven heated to 150° C. for a whole day and night to thermally harden the epoxy resin. The hardened epoxy resin and substrate were rapidly cooled approximately to room temperature to separate the resin containing the capacitor bodies by utilizing a stress difference between the substrate and the resin. Then, epoxy resin was further applied to a separated portion of the resin, and thermally hardened in a similar manner to seal the capacitor bodies. The resin containing the capacitor bodies obtained by the foregoing procedures was cut by a dicer along a cross section of each capacitor body. Then, resin parts provided at both ends of the capacitor body were polished to expose the lower electrode layers on one of the end surfaces, and the upper electrode layers on the other end surface. The first external electrode and the second external electrode were formed by electroplating on the corresponding exposed end surfaces (exposure surfaces), respectively. The upper electrode layer was connected to the first external electrode, while the lower electrode layer was connected to the second external electrode. The roll-up type capacitor according to Example 2 thus obtained had a cross-sectional shape illustrated in FIG. 8.

(Measurement of Capacitance and ESR)

The 30 roll-up type capacitors according to Example 2 were prepared to measure capacitance and ESR of each of the roll-up type capacitors by measurement procedures similar to the procedures of Example 1 and Comparative Example 1. As a result, capacitance of 1 nF was obtained for all of the 30 roll-up type capacitors for the entire frequency range similarly to Example 1. The ESR of all the 30 roll-up type capacitors was 2.5Ω.

The capacitor according to the present invention realizes size reduction, high capacitance, and high reliability. Accordingly, the capacitor according to the present invention is appropriate for use as a capacitor equipped on various types of electronic devices.

### REFERENCE SIGNS LIST

1: Roll-up type capacitor
2: Cylindrical part
4: First external electrode
6: Second external electrode
8: Resin part
10: Laminate
12: Lower electrode layer
13: Imparting part
14: Dielectric layer
16: Upper electrode layer
18: Insulating layer
20: Second insulating layer
21: Second dielectric layer
22: Third electrode layer
25: Diffusion-preventing layer
26: Adhering layer
27: Interfacial layer
32: Substrate
34: Sacrificial layer
36: Photoresist
38: Photoresist pattern
40: Sacrificial layer pattern
42: Photoresist

1. A roll-up type capacitor comprising:
at least one cylindrical part, the cylindrical part comprising a rolled-up laminate having at least a lower electrode layer and an upper electrode layer with at least a dielectric layer sandwiched therebetween;
a first external electrode at a first end of the cylindrical part and electrically connected to the upper electrode layer; and
a second external electrode at a second end of the cylindrical part opposite the first end and electrically connected to the lower electrode layer; and
a thickness of the upper electrode layer at a first part thereof that is connected to the first external electrode is larger than a thickness of a second part of the upper electrode layer, and/or a thickness of the lower electrode layer at a third part thereof that is connected to the second external electrode is larger than a thickness of a fourth part of the lower electrode layer.

2. The roll-up type capacitor according to claim 1, wherein the cylindrical part further comprises a diffusion-preventing layer laminated under the lower electrode layer such that the lower electrode layer is sandwiched between the dielectric layer and the diffusion-preventing layer.

3. The roll-up type capacitor according to claim 2, further comprising an adhering layer between the diffusion-preventing layer and the lower electrode layer.

4. The roll-up type capacitor according to claim 1, wherein the cylindrical part further comprises an interfacial layer laminated between the dielectric layer and the upper electrode layer and/or between the dielectric layer and the lower electrode layer.

5. The roll-up type capacitor according to claim 1, wherein the cylindrical part further comprises an insulating layer laminated under the lower electrode layer in the laminate such that the lower electrode layer is sandwiched between the dielectric layer and the insulating layer.

6. The roll-up type capacitor according to claim 1, wherein the dielectric layer is a first dielectric layer, and wherein the cylindrical part further comprises a second dielectric layer and third electrode layer on the upper electrode layer.

7. The roll-up type capacitor according to claim 1, further comprising a resin part covering the cylindrical part.

8. The roll-up type capacitor according to claim 7, wherein the at least one cylindrical part is two or more cylindrical parts arranged parallel to one another.

9. The roll-up type capacitor according to claim 1, wherein the thickness of the upper electrode layer at the first part thereof that is connected to the first external electrode is larger than the thickness of a second part of the upper electrode layer, and the thickness of the lower electrode layer at the third part thereof that is connected to the second external electrode is larger than the thickness of the fourth part of the lower electrode layer.

10. A method for producing a roll-up type capacitor, the method comprising:
forming a sacrificial layer on a substrate;
forming a laminate comprising at least a lower electrode layer, an upper electrode layer and a dielectric layer sandwiched between the lower electrode layer and the upper electrode layer on the sacrificial layer;
rolling up the laminate by removal of the sacrificial layer to obtain a cylindrical part;
forming a first external electrode on a first end of the cylindrical part such that the first external electrode is electrically connected to the upper electrode layer;
forming a second external electrode on a second end of the cylindrical part opposite the first end such that the second external electrode is electrically connected to the lower electrode layer; and
when forming the laminate, forming a first imparting part on the upper electrode layer at a part thereof where the upper electrode layer is connected to the first external electrode, and/or forming a second imparting part on the lower electrode layer at a part thereof where the lower electrode layer is connected to the second external electrode.

11. The method according to claim 10, further comprising forming a diffusion-preventing layer before forming the lower electrode layer such that the lower electrode layer is sandwiched between the dielectric layer and the diffusion-preventing layer.

12. The method according to claim 11, further comprising forming an adhesion layer between the diffusion-preventing layer and the lower electrode layer.

13. The method according to claim 10, further comprising forming an interfacial layer between the dielectric layer and the upper electrode layer and/or between the dielectric layer and the lower electrode layer.

14. The method according to claim 10, further comprising forming an insulating layer before forming the lower electrode layer such that the lower electrode layer is sandwiched between the dielectric layer and the insulating layer.

15. The method according to claim 10, wherein dielectric layer is a first dielectric layer, and the method further comprises forming a second dielectric layer and a third electrode layer in this order on the upper electrode layer.

16. The method according to claim 10, further comprising hardening the cylindrical part with a resin before forming the first external electrode and the second external electrode.

17. The method according to claim 16, further comprising forming a plurality of the cylindrical parts and arranging the plurality of cylindrical parts parallel to one another when hardening with the resin.

18. The method according to claim 10, wherein when forming the laminate, both the first imparting part on the upper electrode layer and the second imparting part on the lower electrode layer are formed.

19. The method according to claim 18, wherein the first imparting part is formed of a same material as that of the upper electrode, and the second imparting part is formed of a same material as that of the lower electrode.

20. The method according to claim 10, wherein the first imparting part is formed of a same material as that of the upper electrode, and/or the second imparting part is formed of a same material as that of the lower electrode.
